(19) United States
(12) Patent Application Publication
(10) Pub. No.: US 2025/0096456 A1
(43) Pub. Date: Mar. 20, 2025

(54) METAL MESH FOR DIMMER AND TRANSPARENT ANTENNA

(71) Applicant: Meta Platforms Technologies, LLC, Menlo Park, CA (US)

(72) Inventors: Yasuo Morimoto, Cupertino, CA (US); Jiang Zhu, Cupertino, CA (US); Afsoon Jamali, Issaquah, WA (US)

(21) Appl. No.: 18/441,000

(22) Filed: Feb. 14, 2024

Related U.S. Application Data
(60) Provisional application No. 63/583,777, filed on Sep. 19, 2023.

(51) Int. Cl. H01Q 1/27; H01Q 1/38

(52) U.S. Cl. CPC H01Q 1/273; H01Q 1/38

(57) ABSTRACT

The disclosed system may include a support structure and a lens, mounted to the support structure, that includes a conductive layer with a metal mesh formed into a non-periodic grid. Various other wearable devices, apparatuses, and methods of manufacturing are also disclosed.

### CROSS-REFERENCE TO RELATED APPLICATIONS

This application claims the benefit of U.S. Provisional Patent Application No. 63/582,777 filed 19 Sep. 2023 entitled “Metal Mesh for Dimmer and Transparent Antenna,” the entire contents of which is incorporated by reference herein.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an embodiment of a system 100 with a lens that includes a conductive layer with a non-periodic mesh.

FIG. 2 depicts an embodiment in which the lens of FIG. 1 is implemented in a pair of augmented reality glasses.

FIG. 3 depicts an embodiment in which (1) a mesh in the form of a periodic grid of repeating hexagons results in a light scatter and (2) a version of the periodic grid of hexagons that has been modified to be non-periodic does not result in light scatter.

FIG. 4 depicts an embodiment in which (1) a mesh in the form of a periodic grid of repeating squares results in a light scatter and (2) a version of the periodic grid of squares that has been modified to be non-periodic does not result in light scatter.

FIG. 5 depicts an exemplary process for modifying a periodic pattern into a non-periodic pattern for a metal mesh.

FIG. 6 shows an exemplary periodic pattern with edges, cells, and vertices, in which a mesh pitch and mesh width are delineated.

FIG. 7 provides an exemplary depiction of a conductive layer that includes multiple conductive sublayers.

FIG. 8 depicts an exemplary electronic display that includes a conductive layer with a non-periodic mesh.

FIG. 9 depicts an exemplary method of manufacture for dimensioning the cells of a metal mesh into a non-periodic grid.

FIG. 10 depicts an exemplary augmented-reality system that may include the lens described in connection with FIGS. 1-9.

FIG. 11 depicts an exemplary virtual-reality system that may include the electronic display described in connection with FIGS. 1-9.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

This disclosure is generally directed to a conductive layer (e.g., a conductive film) configured for an electronic display. The electronic display can be used in any of a variety of contexts (e.g., as a lens for a pair of augmented reality glasses, a display element of a mobile device and/or an artificial reality headset, a touchscreen, etc.). In some examples, the conductive layer may include a metal mesh that is in the form of a non-periodic grid.

The conductive layer can enable a variety of functionalities for the electronic display. In some examples, a metal mesh of the conductive layer can be used as a support structure to which other elements, needed for the functioning of the electronic device, can be coupled. Examples of such elements may include, without limitation, a light-emitting element, a photodetector, a light sensor, an antenna, etc. In one example, the conductive layer may represent an active diming layer and may include one or more materials that increase light blockage, when ambient light is high, and decrease light blockage, when ambient light is low.

In examples in which the conductive layer is applied to a substrate that must be seen through (e.g., a lens for augmented reality glasses), engineers balance a trade-off between optics (e.g., the optical transparency of the conductive layer) and electrical sheet resistance (e.g., how well the conductive layer conducts electricity). A metal mesh may have the needed (e.g., ideal) electrical sheet resistance for certain functionalities (e.g., active dimming) and may have the needed level of optical transparency. However, traditional metal meshes take the form of a periodic grid. And structured obstructions (like that of a periodic grid) to a light source can create a scattering of light that is visible to users. Responding to this limitation of traditional metal meshes, this application discloses a metal mesh in the form of a non-period grid that disperses scattering (e.g., such that scattering is no longer visible or is much less visible to users). The non-periodic form of the disclosed metal mesh may also have the benefit of making the metal mesh less visible to the human eye.

In some examples, the conductive layer disclosed herein may include multiple sublayers. In one example, the conductive layer may represent an active dimming layer and may include an electrochromic sublayer (e.g., with an electrochromic material, such as a conductive polymer and/or layered viologen, that undergoes a reversible change in color). Traditionally, the use of an electrochromic sublayer has precluded the use of a metal mesh, as the metal mesh is at risk of being oxidized by the electrochromic material. The present application enables the use of both an electrochromic sublayer and a metal mesh (in the same conductive layer) by positioning a protective conductive layer (e.g., an indium tin oxide (ITO) layer) between the electrochromic sublayer and the metal mesh. In addition to protecting the metal mesh from oxidation, the protective conductive layer may also improve the uniformity of the metal mesh.

Features from any of the embodiments described herein may be used in combination with one another in accordance with the general principles described herein. These and other embodiments, features, and advantages will be more fully understood upon reading the following detailed description in conjunction with the accompanying drawings and claims.

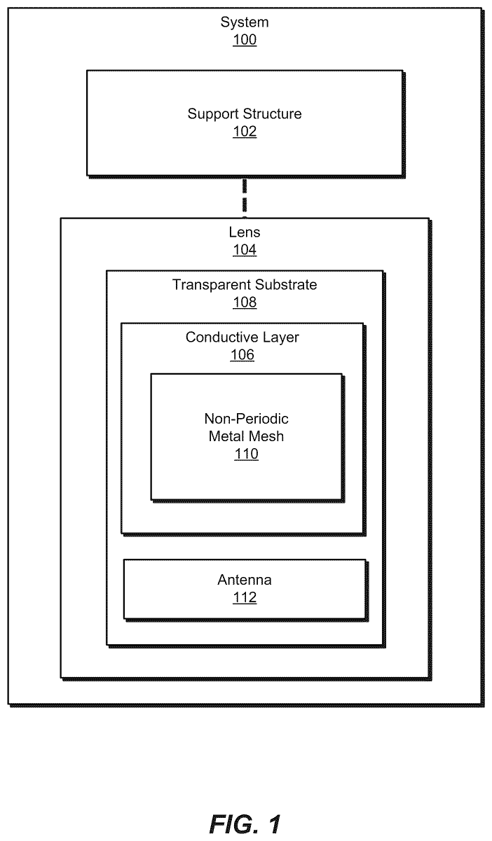

FIG. 1 illustrates an embodiment of a system 100 with a support structure 102 coupled to a lens 104. Lens 104 may include a conductive layer 106 (e.g., applied to a transparent substrate 108) with a metal mesh 110, formed into a non-periodic grid, and/or an antenna 112.

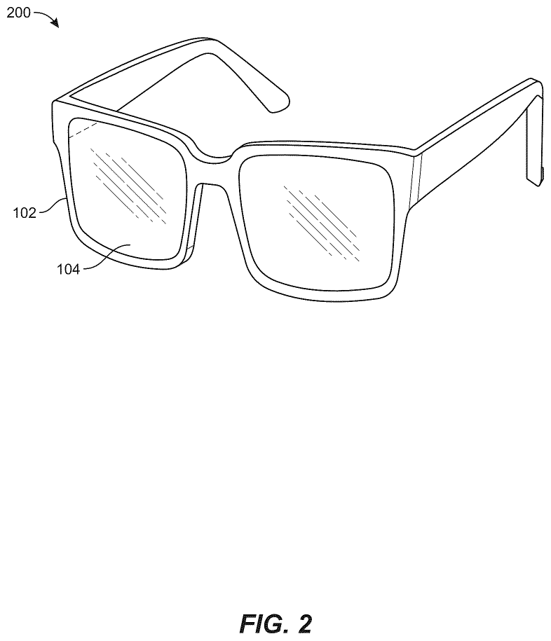

Lens 104 may represent any type or form of optical substrate and support structure 102 may represent any type or form of structure that physically supports lens 104. In some examples, support structure 102 may represent a wearable device (or a component of a wearable device) and lens 104 may represent an electronic display placed within the wearable device. In one example, as illustrated in FIG. 2, lens 104 may represent a lens within a pair of augmented reality glass lenses 200 and support structure 102 may represent a frame.

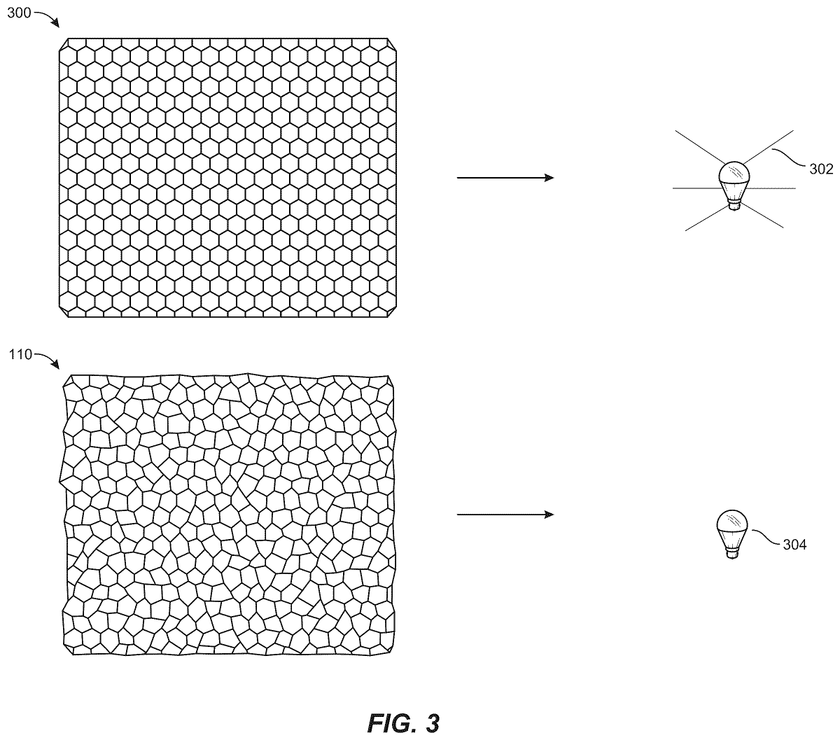

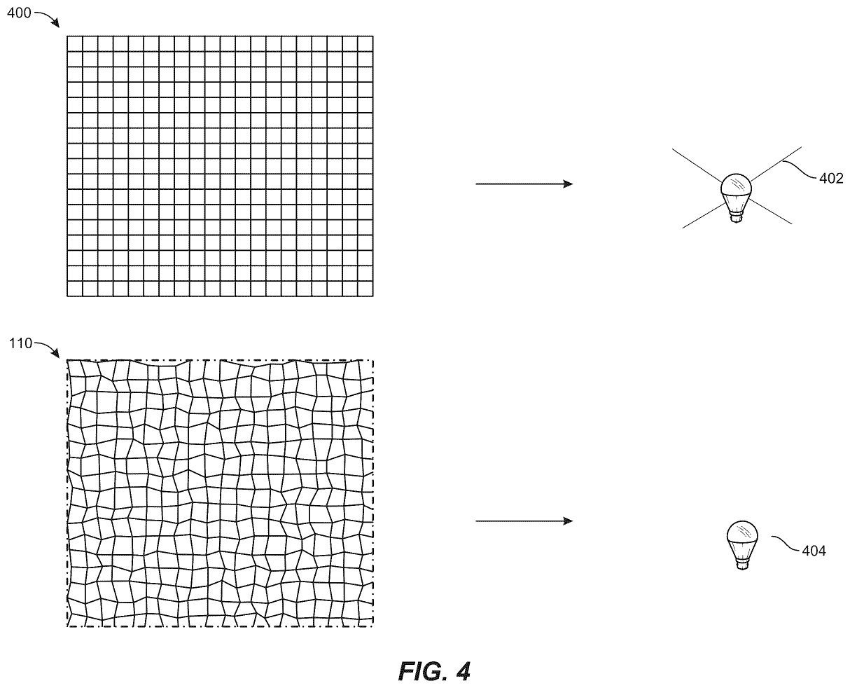

Conductive layer 106 may represent any type or form of layer (e.g., film), applied to transparent substrate 108, that conducts electricity. As mentioned above, conductive layer 106 may include metal mesh 110. One difficulty with metal meshes, which has prohibited or complicated their use in lenses in the past, is that traditional metal meshes take the form of a periodic grid and structured obstructions (like that of a metal mesh in the form of a periodic grid) create a structured haze (e.g., a scattering of light) that is visible to users. For example, as shown in FIG. 3, when light shines through a metal mesh 300 that takes the form of a hexagonal periodic grid (e.g., a grid of hexagons repeating at regular intervals), the light scatters (e.g., into starbursts 302, which are visible to users). Similarly, as shown in FIG. 4, when light shines through a metal mesh that takes the form of square periodic grid (e.g., a grid of squares repeating at regular intervals), the light scatters (e.g., into starbursts 402, which are visible to users). To overcome this limitation of the traditional metal mesh, the present application discloses manufacturing and/or using a metal mesh that takes the form of a non-periodic grid (i.e., a grid that disperses light scatters).

Metal mesh 110 generally represents any type or form of electrically conductive mesh that takes the form of a non-periodic grid. Each cell of the non-periodic grid (or any grid described herein) is delineated by a set of edges (e.g., the metal lines of the mesh) that connect at connection points referred to as vertices. Metal mesh 110 may be formed from any type of conductive material. Exemplary materials include, without limitation, carbon nanotubes, graphene, or metallic nanotubes. As will be described later in greater detail, metal mesh 110 may enable a variety of functionalities. In some examples, metal mesh 110 may create a support structure (e.g., to which one or more elements may be coupled).

The cells of metal mesh 110 may be dimensioned (to form a non-periodic grid) in a variety of ways. In some examples, the non-periodic grid may represent a modified version of a periodic grid. The periodic grid may include regularly spaced cells, whose edges and vertices form a symmetric shape. FIG. 3 depicts an embodiment in which the periodic grid (which is modified to create the non-periodic grid of metal mesh 110) represents a grid of repeating hexagons (i.e., the pattern shown in metal mesh 300). FIG. 4 depicts an embodiment in which the periodic grid (which is modified to create the non-periodic grid of metal mesh 110) represents a grid of repeating squares (i.e., the pattern shown in metal mesh 400).

The periodic grid may be modified to form the non-periodic grid of metal mesh 110 in a variety of ways. In some examples, a cell (e.g., each cell) of the periodic grid may be modified by altering a length of one or more edges of the cell (e.g., each edge of the cell) such that a resulting shape formed by the edges of the cell becomes non-symmetric. In examples in which multiple (e.g., all) cells (e.g., cells with the same dimensions) are modified, each of the vertices of the cells to be modified may be assigned (e.g., randomized) to one of a designated number of groups (e.g., three groups). Additionally, (1) a normal distributed circle area (e.g., drawn around a single vertex of a cell) may be determined and (2) each group may be associated with a different designated number. Then, for each group, the vertices in the group may be located to an area that is the number (designated for that group) of sigma circles of the normal distributed circle area.

As a specific example, in an embodiment in which the vertices, to be modified, are assigned (e.g., randomized) to three groups, the first group of vertices may be located to a first area within one sigma circle of the normal distributed circle area, the second group of vertices may be located to a second area within two sigma circles of the normal distributed circle area, and the third group of vertices may be located to a third area within three sigma circles of the normal distributed circle area. In one such embodiment, the vertices may be randomized such that 68% of the vertices are located within the first area, 95.4% are located within the second area, and 99.7% are located within the third area.

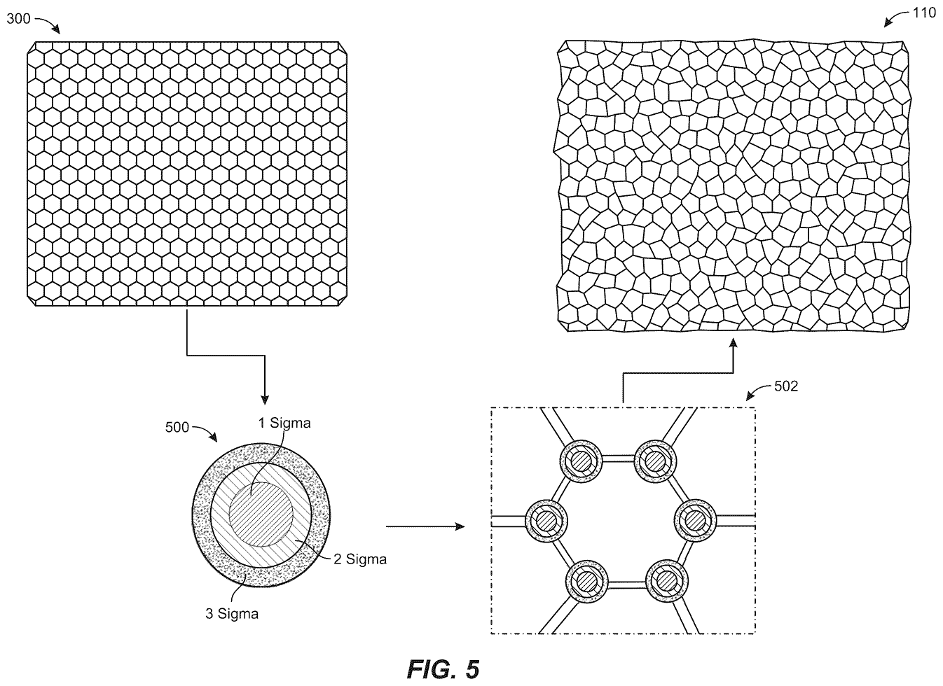

FIG. 5 depicts a flow in which a periodic pattern of hexagons (of uniform size that repeat at a regular interval) is modified to a non-periodic pattern. In FIG. 5, a first, second, and third sigma circle are identified around a normal distributed circle area for each vertex within the periodic pattern. Element 500 shows three sigma circles drawn around a normal distributed circle area. Element 502 shows a cell with three sigma circles drawn around each vertex. After the sigma circles are identified, the vertices of the periodic pattern are randomly assigned to a location within the first, second, or third sigma circles such that 68% of the vertices are located within the first sigma circle, 95.4% are located within the second sigma circle, and 99.7% are located within the third sigma circle. The result, shown on the right, is a non-periodic pattern (i.e., a pattern of non-periodic hexagons). While FIG. 5 shows an exemplary process for modifying a pattern of repeating hexagons, the same exemplary process may be applied to modify a pattern of any other repeating shape (e.g., a pattern of a repeating square such as the pattern shown in FIG. 4).

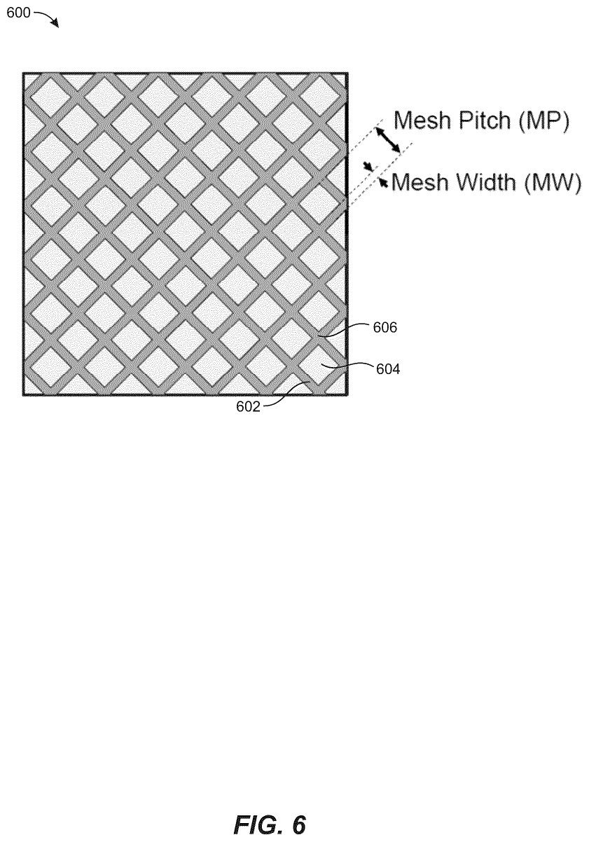

In some examples in which the non-periodic grid of metal mesh 110 is a modified version of a periodic grid, the non-periodic grid may be configured such that the aperture ratio for the non-periodic grid is the same as the aperture ratio for the periodic grid. In these examples, the process described above in connection with FIG. 5 may result in an unchanged aperture ratio. In some examples, the aperture ratio may be defined as ((Mesh Pitch−Mesh Width)/Mesh Pitch))\hat{ }2, where mesh pitch refers to a distance (within a cell of a pattern) between two contralateral edges and mesh width refers to a width of an edge. To illustrate an aperture ratio, FIG. 6 shows an exemplary pattern 600 with edges (e.g., an edge 602), cells (e.g., a cell 604), and vertices (e.g., vertex 606), where a mesh pitch and mesh width are highlighted.

Additionally or alternatively, the non-periodic grid may be configured such that the average pitch width for the non-periodic grid is the same as the average pitch width for the periodic grid (e.g., in 0 and 90 degrees for a modified periodic square pattern and in 0, 60, and 120 degrees for a modified periodic hexagon pattern). In these examples, the unchanged average pitch may be achieved by performing the steps of the process described in connection with FIG. 5. For example, in examples in which each vertex within a periodic pattern is randomized (to one of a determined number of sigma circles as described above), the hexagon will also be randomized but the overall pitch width will remain the same on average. As result, the overall resistivity of the resulting metal mesh will be unaffected (while the optical transparency of the resulting metal mesh will be improved). In some examples, metal mesh 110 may be configured to weaken scattering in a specific direction (e.g., −90 degrees) based on the use of the electronic display into which metal mesh 110 is incorporated.

In some examples, metal mesh 110 may include multiple integrated patterns. For example, metal mesh 110 may include a non-periodic pattern in certain areas (e.g., areas corresponding to a region of lens 104 through which a user gazes) and a solid and/or periodic pattern in other areas (e.g., areas corresponding to a region of lens 104 that are positioned behind support structure 102 and/or a cosmetic cover of support structure 102).

In some examples, conductive layer 106 may include multiple sublayers (e.g., directed to a functionality enabled by conductive layer 106). For example, in some examples, conductive layer 106 may represent an active dimming layer configured to actively dim incoming light and the sublayers of conductive layer 106 may include a metal mesh sublayer (including metal mesh 110) and an electrochromic sublayer. The electrochromic sublayer may include or represent any type of material that undergoes a reversible change in color in response to an applied electric current (e.g., applied via metal mesh 110), such as a conductive polymer (e.g., a liquid crystal polymer) and/or a layered viologen. In some such examples, to protect metal mesh 110 from oxidation from the electrochromic sublayer, the sublayers may also include a protective conductive sublayer with a conductive material that is not at risk of being oxidized, such as indium tin oxide (ITO) (e.g., an amorphous ITO and/or a crystalized ITO). The protective conductive sublayer may also improve, for metal mesh 110, the uniformity of electrical (e.g., current) distributions. In some examples in which metal mesh 110 represents and/or includes an antenna (e.g., antenna 112), the protective conductive sublayer may also improve the performance of the antenna. The protective conductive sublayer may be configured to have any sheet resistance. Exemplary sheet resistances for the protective conductive sublayer include, without limitation, 50 Ohm/sq, 100 Ohm/sq, and/or 150 Ohm/sq. In some embodiments, the protective conductive sublayer may be configured to have a sheet resistance that is greater than the sheet resistance of metal mesh 110.

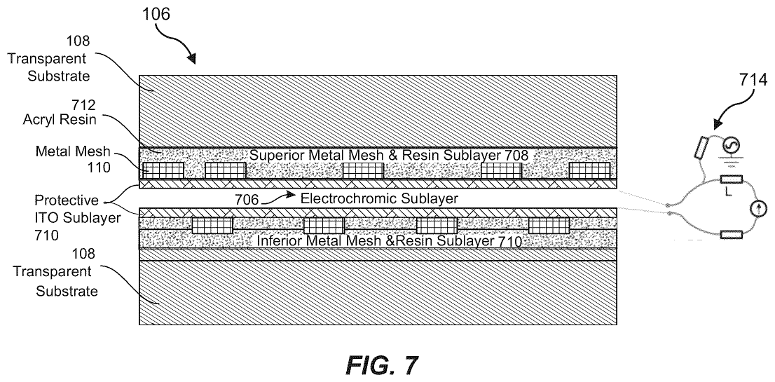

FIG. 7 provides an exemplary depiction of conductive layer 106 that includes two metal mesh sublayers (a superior metal mesh sublayer 702 and an inferior metal mesh sublayer 704), a central electrochromic sublayer 706 (positioned centrally relative to the two metal mesh sublayers), and two protective sublayers (a superior protective sublayer 708 and an inferior protective sublayer 710) positioned between electrochromic sublayer 706 and the metal mesh sublayers. In some examples, as illustrated in FIG. 7, a metal mesh sublayer may include a support resin (e.g., an acryl resin 712) and an instance of metal mesh 110.

In some examples in which conductive layer 106 includes a resin layer (e.g., acryl resin 712 in FIG. 7), the resin layer may be configured to have a refractive index number that falls between a refractive index number of a base substrate (e.g., transparent substrate 108 in FIG. 7) of conductive layer 106 and a refractive index number of a protective conductive sublayer (e.g., protective ITO substrate 710 in FIG. 7) of conductive layer 106. As a specific example, transparent substrate 108 may have a refractive index number of 1.53 and protective ITO substrate 710 may have a refractive index number of 2.1. In this specific example, acryl resin 712 may be configured to have a refractive index number that falls between 1.53 and 2.1.

In some examples in which conductive layer 106 includes multiple sublayers, conductive layer 106 may include an index match layer (e.g., positioned between a protective ITO sublayer and a support resin sublayer). In one such example, the index match layer may be configured to have a refractive index number that falls between the refractive index number of the protective ITO sublayer and the refractive index number of the support resin sublayer.

In some examples in which conductive layer 106 represents or includes an active dimming layer, a dimming source for conductive layer 106 may be included within support structure 102. In these examples, conductive layer 106 may be coupled to the dimming source (e.g., via a wire trace). In some examples, the active dimming layer may include or be coupled to a suspended particle device. Additionally or alternatively, the active dimming layer may include or be coupled to liquid crystal.

In one example, lens 104 may include and/or support an antenna (e.g., antenna 112). In some examples, the antenna may be integrated with transparent substrate 108 of lens 104 (e.g., via lamination and/or being casted and/or three-dimensionally printed inside transparent substrate 108). Additionally or alternatively, one or more metal mesh sublayers of conductive layer 106 may include the antenna and/or components of the antenna. In one such example, the main antenna design may be integrated with a first metal mesh layer and additional antenna architecture may be integrated with a second metal mesh layer. The antenna may be substantially any type of antenna including a monopole antenna, a dipole antenna, a slit antenna, a loop antenna, or other type of antenna. The antenna may be designed for any specific implementation including Wifi, Bluetooth, cellular (e.g., long term evolution (LTE)), ultrawideband (UWB), global positioning system (GPS), or other antenna implementations.

In some examples in which conductive layer 106 represents or includes an antenna, a radio frequency source (e.g., a device that emits radio frequency signals) may be included within support structure 102. In these examples, conductive layer 106 may be coupled to the radio frequency source (e.g., via a wire trace). In some examples, support structure 102 may also include a signal-separating source, such as a bias-tee, an RF-choke, or a DC-block. FIG. 7 depicts an exemplary source circuit 714 (e.g., which may be used for active dimming and/or an antenna).

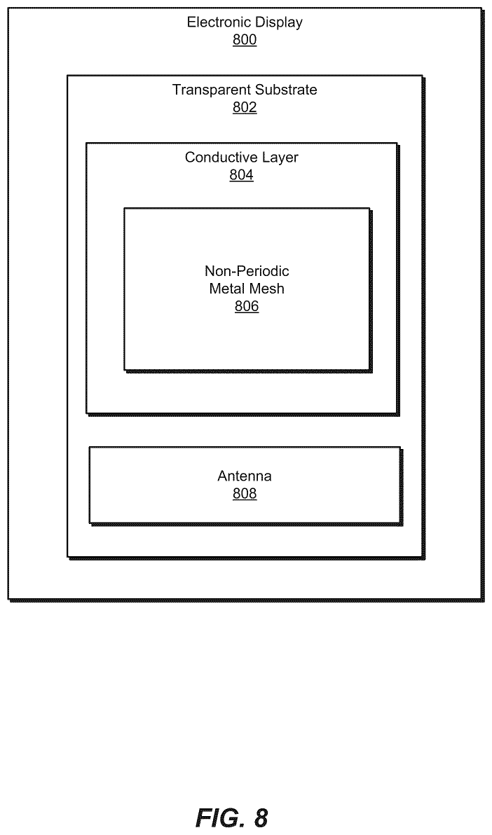

FIG. 8 depicts an exemplary electronic display 800 that includes a transparent substrate 802 and a conductive layer 804, coupled to transparent substrate 802, that includes a metal mesh 806 in the form of a non-periodic grid. In some examples, electronic display 800 may also include an antenna 808. Electronic display 800 may represent any type or form of display element within a device. Electronic display 800 can be used in any of a variety of contexts (e.g., as a lens for a pair of augmented reality glasses, a display element such as a screen of a mobile device and/or an artificial reality headset, a touchscreen, etc.). Electronic display 800 may include any of the features described herein in connection with lens 104 of FIG. 1. Similarly, transparent substrate 802, conductive layer 804, non-periodic metal mesh 806, and antenna 808 may include any of the features described herein in connection with transparent substrate 108, conductive layer 106, non-periodic metal mesh 110, and antenna 112 of FIG. 1.

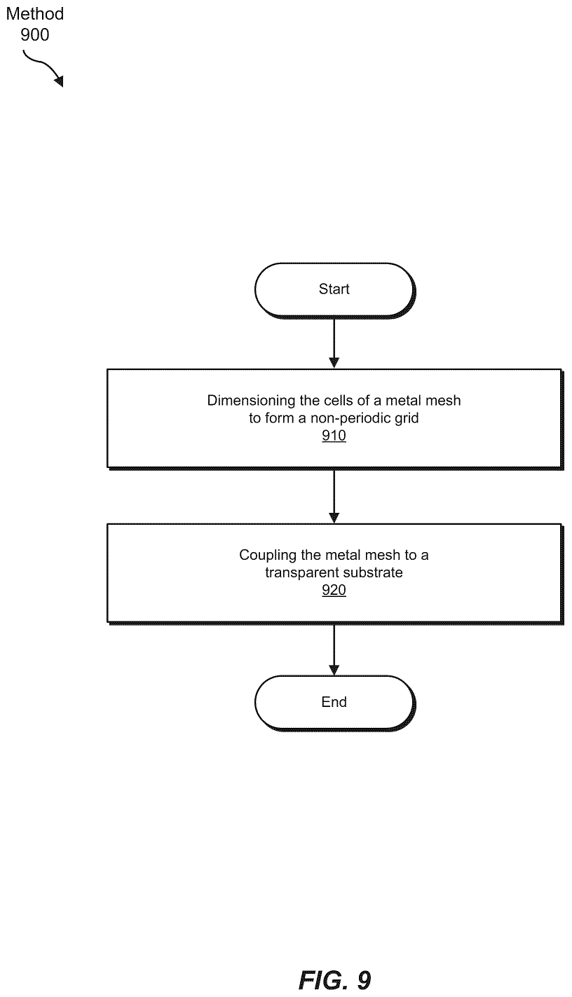

FIG. 9 depicts an exemplary method 900 of manufacture. At step 910, one or more of the systems described herein may dimension the cells of a metal mesh (e.g., metal mesh 110 in FIG. 1) to form a non-periodic grid. Then, at step 920, one or more of the systems described herein may couple the metal mesh to a transparent substrate (e.g., transparent substrate 108 in FIG. 1). The one or more systems described herein may perform the steps of method 900 using any of the systems, processes, elements, or features described herein (e.g., in connection with FIGS. 1-8).

### EXAMPLE EMBODIMENTS

Example 1: A system including a support structure and a lens, mounted to the support structure, that includes a conductive layer with a metal mesh formed into a non-periodic grid.

Example 2: The system of Example 1 in which the non-periodic grid represents a modified version of a periodic grid, the periodic grid includes regularly spaced cells, each cell delineated by edges and vertices that form a symmetric shape, and the periodic grid is modified to create the non-periodic grid by altering, for at least one of the cells, a length of one or more edges of the cell such that a resulting shape formed by the edges and vertices of the cell is non-symmetric.

Example 3: The system of Examples 1-2, where altering the length of one or more edges of the cell includes altering the length of each of the edges of the cell.

Example 4: The system of Examples 2-3, where altering, for at least one of the cells, the length of one or more the edges of the cell includes locating a first subset of the vertices, within the cells, to a first area within one sigma circle of a normal distributed circle area corresponding to a single cell within the plurality of cells, and locating a second subset of the vertices, within the cells, to a second area within two sigma circles of the normal distributed circle area.

Example 5: The system of Example 4, where altering, for at least one of the cells, the length of one or more of the edges further includes locating a third subset of the vertices, within the cells, to a third area within three sigma circles of the normal distributed circle area.

Example 6: The system of Examples 2-5, where a measure of overall pitch for the periodic grid is equivalent to a measure of overall pitch for the non-periodic grid.

Example 7: The system of Examples 2-6, where the periodic grid includes a repeating shape.

Example 8: The system of Example 7, where the repeating shape is at least a square and/or a hexagon.

Example 9: The system of Examples 1-8, where the conductive layer includes an active dimming layer configured to actively dim incoming light.

Example 10: The system of Example 9, where the conductive layer includes multiple sublayers (e.g., a metal mesh sublayer including the metal mesh, an electrochromic sublayer, and a protective conductive sublayer positioned between the metal mesh sublayer and the electrochromic sublayer to protect the metal mesh from being oxidized by the electrochromic sublayer).

Example 11: The system of Example 10, where the protective conductive sublayer includes indium tin oxide (ITO).

Example 12: The system of Examples 1-11, where the system further includes an antenna integrated with the lens.

Example 13: The system of Example 12, where the antenna is integrated with the lens via lamination, casting, and/or three-dimensional printing.

Example 14: An electronic display including a transparent substrate and a conductive layer, coupled to the transparent substrate, that includes a metal mesh in the form of a non-periodic grid.

Example 15: The electronic display of Example 14, where the non-periodic grid represents a modified version of a periodic grid, the periodic grid includes regularly spaced cells, each cell including a plurality of edges and vertices that form a symmetric shape, and the periodic grid is modified to create the non-periodic grid by altering, for at least one of the cells, a length of one or more edges of the cell such that a resulting shape formed by the edges of the cell is non-symmetric.

Example 16: The electronic display of Examples 14-15, where the conductive layer includes an active dimming layer configured to actively dim incoming light.

Example 17: The electronic display of Example 16, where the conductive layer includes multiple sublayers (e.g., a metal mesh sublayer including the metal mesh, an electrochromic sublayer, and a protective conductive sublayer positioned between the metal mesh sublayer and the electrochromic sublayer).

Example 18: The electronic display of Examples 15-17, further including an antenna integrated with the transparent substrate.

Example 19: A method of manufacturing including (1) dimensioning one or more cells of a metal mesh to form a non-periodic grid and (2) coupling the metal mesh to a transparent substrate.

Example 20: The method of Example 19, where the non-periodic grid represents a modified version of a periodic grid, the periodic grid includes regularly spaced cells, each cell including edges and vertices that form a symmetric shape, and dimensioning the one or more cells of the metal mesh includes altering one or more cells of the periodic grid by altering, for at least one of the cells of the periodic grid, a length of one or more edges of the cell such that a resulting shape formed by the edges of the cell is non-symmetric.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

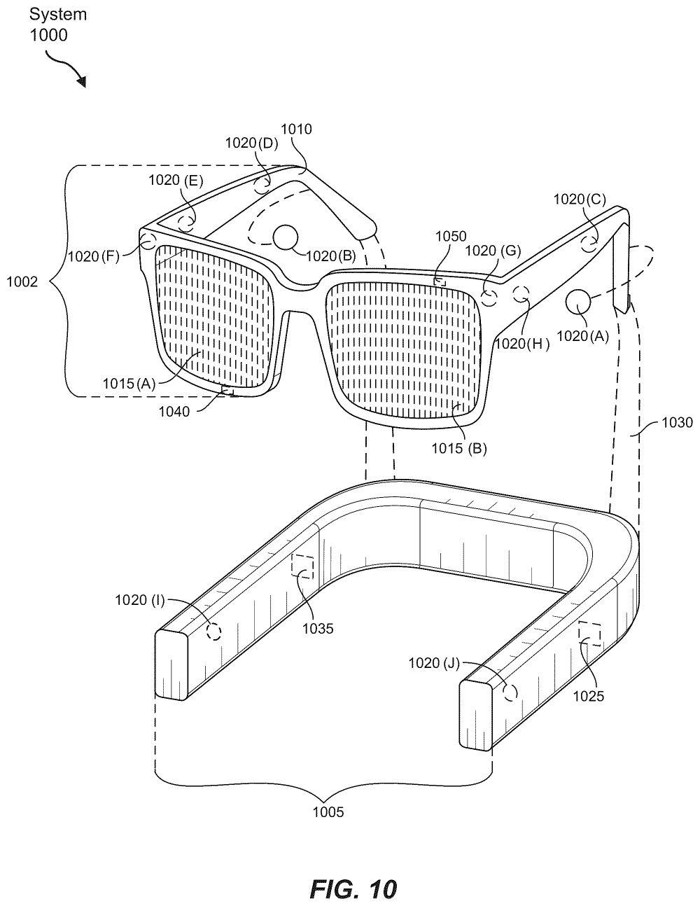

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1000 in FIG. 10) or that visually immerses a user in an artificial reality (such as, e.g., virtual-reality system 1000 in FIG. 10). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 10, augmented-reality system 1000 may include an eyewear device 1002 with a frame 1010 configured to hold a left display device 1015(A) and a right display device 1015(B) in front of a user's eyes. Display devices 1015(A) and 1015(B) may act together or independently to present an image or series of images to a user. While augmented-reality system 1000 includes two displays, embodiments of this disclosure may be implemented in augmented-reality systems with a single NED or more than two NEDs.

In some embodiments, augmented-reality system 1000 may include one or more sensors, such as sensor 1040. Sensor 1040 may generate measurement signals in response to motion of augmented-reality system 1000 and may be located on substantially any portion of frame 1010. Sensor 1040 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1000 may or may not include sensor 1040 or may include more than one sensor. In embodiments in which sensor 1040 includes an IMU, the IMU may generate calibration data based on measurement signals from sensor 1040. Examples of sensor 1040 may include, without limitation, accelerometers, gyroscopes, magnetometers, other suitable types of sensors that detect motion, sensors used for error correction of the IMU, or some combination thereof.

In some examples, augmented-reality system 1000 may also include a microphone array with a plurality of acoustic transducers 1020(A)-1020(J), referred to collectively as acoustic transducers 1020. Acoustic transducers 1020 may represent transducers that detect air pressure variations induced by sound waves. Each acoustic transducer 1020 may be configured to detect sound and convert the detected sound into an electronic format (e.g., an analog or digital format). The microphone array in FIG. 10 may include, for example, ten acoustic transducers: 1020(A) and 1020(B), which may be designed to be placed inside a corresponding ear of the user, acoustic transducers 1020(C), 1020(D), 1020(E), 1020(F), 1020(G), and 1020(H), which may be positioned at various locations on frame 1010, and/or acoustic transducers 1020(I) and 1020(J), which may be positioned on a corresponding neckband 1005.

In some embodiments, one or more of acoustic transducers 1020(A)-(J) may be used as output transducers (e.g., speakers). For example, acoustic transducers 1020(A) and/or 1020(B) may be earbuds or any other suitable type of headphone or speaker.

The configuration of acoustic transducers 1020 of the microphone array may vary. While augmented-reality system 1000 is shown in FIG. 10 as having ten acoustic transducers 1020, the number of acoustic transducers 1020 may be greater or less than ten. In some embodiments, using higher numbers of acoustic transducers 1020 may increase the amount of audio information collected and/or the sensitivity and accuracy of the audio information. In contrast, using a lower number of acoustic transducers 1020 may decrease the computing power required by an associated controller 1050 to process the collected audio information. In addition, the position of each acoustic transducer 1020 of the microphone array may vary. For example, the position of an acoustic transducer 1020 may include a defined position on the user, a defined coordinate on frame 1010, an orientation associated with each acoustic transducer 1020, or some combination thereof.

Acoustic transducers 1020(A) and 1020(B) may be positioned on different parts of the user's ear, such as behind the pinna, behind the tragus, and/or within the auricle or fossa. Or, there may be additional acoustic transducers 1020 on or surrounding the ear in addition to acoustic transducers 1020 inside the ear canal. Having an acoustic transducer 1020 positioned next to an ear canal of a user may enable the microphone array to collect information on how sounds arrive at the ear canal. By positioning at least two of acoustic transducers 1020 on either side of a user's head (e.g., as binaural microphones), augmented-reality device 1000 may simulate binaural hearing and capture a 3D stereo sound field around about a user's head. In some embodiments, acoustic transducers 1020(A) and 1020(B) may be connected to augmented-reality system 1000 via a wired connection 1030, and in other embodiments acoustic transducers 1020(A) and 1020(B) may be connected to augmented-reality system 1000 via a wireless connection (e.g., a BLUETOOTH connection). In still other embodiments, acoustic transducers 1020(A) and 1020(B) may not be used at all in conjunction with augmented-reality system 1000.

Acoustic transducers 1020 on frame 1010 may be positioned in a variety of different ways, including along the length of the temples, across the bridge, above or below display devices 1015(A) and 1015(B), or some combination thereof. Acoustic transducers 1020 may also be oriented such that the microphone array is able to detect sounds in a wide range of directions surrounding the user wearing the augmented-reality system 1000. In some embodiments, an optimization process may be performed during manufacturing of augmented-reality system 1000 to determine relative positioning of each acoustic transducer 1020 in the microphone array.

In some examples, augmented-reality system 1000 may include or be connected to an external device (e.g., a paired device), such as neckband 1005. Neckband 1005 generally represents any type or form of paired device. Thus, the following discussion of neckband 1005 may also apply to various other paired devices, such as charging cases, smart watches, smart phones, wrist bands, other wearable devices, hand-held controllers, tablet computers, laptop computers, other external compute devices, etc.

As shown, neckband 1005 may be coupled to eyewear device 1002 via one or more connectors. The connectors may be wired or wireless and may include electrical and/or non-electrical (e.g., structural) components. In some cases, eyewear device 1002 and neckband 1005 may operate independently without any wired or wireless connection between them. While FIG. 10 illustrates the components of eyewear device 1002 and neckband 1005 in example locations on eyewear device 1002 and neckband 1005, the components may be located elsewhere and/or distributed differently on eyewear device 1002 and/or neckband 1005. In some embodiments, the components of eyewear device 1002 and neckband 1005 may be located on one or more additional peripheral devices paired with eyewear device 1002, neckband 1005, or some combination thereof.

Pairing external devices, such as neckband 1005, with augmented-reality eyewear devices may enable the eyewear devices to achieve the form factor of a pair of glasses while still providing sufficient battery and computation power for expanded capabilities. Some or all of the battery power, computational resources, and/or additional features of augmented- reality system 1000 may be provided by a paired device or shared between a paired device and an eyewear device, thus reducing the weight, heat profile, and form factor of the eyewear device overall while still retaining desired functionality. For example, neckband 1005 may allow components that would otherwise be included on an eyewear device to be included in neckband 1005 since users may tolerate a heavier weight load on their shoulders than they would tolerate on their heads. Neckband 1005 may also have a larger surface area over which to diffuse and disperse heat to the ambient environment. Thus, neckband 1005 may allow for greater battery and computation capacity than might otherwise have been possible on a stand-alone eyewear device. Since weight carried in neckband 1005 may be less invasive to a user than weight carried in eyewear device 1002, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1005 may be communicatively coupled with eyewear device 1002 and/or to other devices. These other devices may provide certain functions (e.g., tracking, localizing, depth mapping, processing, storage, etc.) to augmented-reality system 1000. In the embodiment of FIG. 10, neckband 1005 may include two acoustic transducers (e.g., 1020(I) and 1020(J)) that are part of the microphone array (or potentially form their own microphone subarray). Neckband 1005 may also include a controller 1025 and a power source 1035.

Acoustic transducers 1020(I) and 1020(J) of neckband 1005 may be configured to detect sound and convert the detected sound into an electronic format (analog or digital). In the embodiment of FIG. 10, acoustic transducers 1020(I) and 1020(J) may be positioned on neckband 1005, thereby increasing the distance between the neckband acoustic transducers 1020(I) and 1020(J) and other acoustic transducers 1020 positioned on eyewear device 1002. In some cases, increasing the distance between acoustic transducers 1020 of the microphone array may improve the accuracy of beamforming performed via the microphone array. For example, if a sound is detected by acoustic transducers 1020(C) and 1020(D) and the distance between acoustic transducers 1020(C) and 1020(D) is greater than, e.g., the distance between acoustic transducers 1020(D) and 1020(E), the determined source location of the detected sound may be more accurate than if the sound had been detected by acoustic transducers 1020(D) and 1020(E).

Controller 1025 of neckband 1005 may process information generated by the sensors on neckband 1005 and/or augmented-reality system 1000. For example, controller 1025 may process information from the microphone array that describes sounds detected by the microphone array. For each detected sound, controller 1025 may perform a direction-of-arrival (DOA) estimation to estimate a direction from which the detected sound arrived at the microphone array. As the microphone array detects sounds, controller 1025 may populate an audio data set with the information. In embodiments in which augmented-reality system 1000 includes an inertial measurement unit, controller 1025 may compute all inertial and spatial calculations from the IMU located on eyewear device 1002. A connector may convey information between augmented-reality system 1000 and neckband 1005 and between augmented-reality system 1000 and controller 1025. The information may be in the form of optical data, electrical data, wireless data, or any other transmittable data form. Moving the processing of information generated by augmented-reality system 1000 to neckband 1005 may reduce weight and heat in eyewear device 1002, making it more comfortable to the user.

Power source 1035 in neckband 1005 may provide power to eyewear device 1002 and/or to neckband 1005. Power source 1035 may include, without limitation, lithium-ion batteries, lithium-polymer batteries, primary lithium batteries, alkaline batteries, or any other form of power storage. In some cases, power source 1035 may be a wired power source. Including power source 1035 on neckband 1005 instead of on eyewear device 1002 may help better distribute the weight and heat generated by power source 1035.

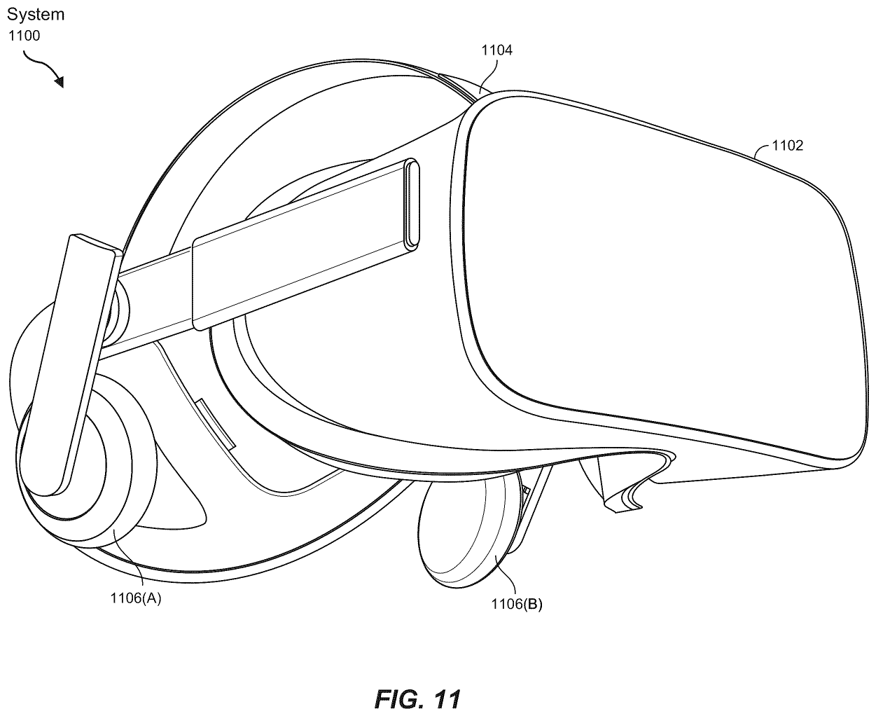

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1100 in FIG. 11, that mostly or completely covers a user's field of view. Virtual-reality system 1100 may include a front rigid body 1102 and a band 1104 shaped to fit around a user's head. Virtual-reality system 1100 may also include output audio transducers 1106(A) and 1106(B). Furthermore, while not shown in FIG. 11, front rigid body 1102 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1000 and/or virtual-reality system 1100 may include one or more liquid crystal displays (LCDs), light emitting diode (LED) displays, microLED displays, organic LED (OLED) displays, digital light projector (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1000 and/or virtual-reality system 1100 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1000 and/or virtual-reality system 1100 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a support structure; and
a lens mounted to the support structure, the lens comprising a conductive layer with a metal mesh formed into a non-periodic grid.

2. The system of claim 1, wherein:
the non-periodic grid represents a modified version of a periodic grid;
the periodic grid comprises a plurality of regularly spaced cells, each cell delineated by a plurality of edges and vertices that form a symmetric shape; and
the periodic grid is modified to create the non-periodic grid by altering, for at least one of the cells, a length of one or more edges of the cell such that a resulting shape formed by the edges and vertices of the cell is non-symmetric.

3. The system of claim 2, wherein altering the length of one or more edges of the cell comprises altering the length of each of the edges of the cell.

4. The system of claim 2, wherein altering, for at least one of the cells, the length of one or more the edges of the cell comprises:
locating a first subset of the vertices, within the plurality of cells, to a first area within one sigma circle of a normal distributed circle area corresponding to a single cell within the plurality of cells; and
locating a second subset of the vertices, within the plurality of cells, to a second area within two sigma circles of the normal distributed circle area.

5. The system of claim 4, wherein altering, for at least one of the cells, the length of one or more of the edges further comprises locating a third subset of the vertices, within the plurality of cells, to a third area within three sigma circles of the normal distributed circle area.

6. The system of claim 2, wherein a measure of overall pitch for the periodic grid is equivalent to a measure of overall pitch for the non-periodic grid.

7. The system of claim 2, wherein the periodic grid comprises a repeating shape.

8. The system of claim 7, wherein the repeating shape comprises at least one of a square or a hexagon.

9. The system of claim 1, wherein the conductive layer comprises an active dimming layer configured to actively dim incoming light. 10 The system of claim 9, wherein the conductive layer comprises a plurality of sublayers, the plurality of sublayers comprising a metal mesh sublayer comprising the metal mesh, an electrochromic sublayer, and a protective conductive sublayer positioned between the metal mesh sublayer and the electrochromic sublayer.

11. The system of claim 10, wherein the protective conductive sublayer comprises indium tin oxide (ITO).

12. The system of claim 1, wherein the system further comprises an antenna integrated with the lens.

13. The system of claim 12, wherein the antenna is integrated with the lens via at least one of lamination, casting, or three-dimensional printing.

14. An electronic display comprising:
a transparent substrate; and
a conductive layer, coupled to the transparent substrate comprising a metal mesh in the form of a non-periodic grid.

15. The electronic display of claim 14, wherein:
the non-periodic grid represents a modified version of a periodic grid;
the periodic grid comprises a plurality of regularly spaced cells, each cell comprising a plurality of edges and vertices that form a symmetric shape; and
the periodic grid is modified to create the non-periodic grid by altering, for at least one of the cells, a length of one or more edges of the cell such that a resulting shape formed by the edges of the cell is non-symmetric.

16. The electronic display of claim 14, wherein the conductive layer comprises an active dimming layer configured to actively dim incoming light.

17. The electronic display of claim 16, wherein the conductive layer comprises a plurality of sublayers, the plurality of sublayers comprising a metal mesh sublayer comprising the metal mesh, an electrochromic sublayer, and a protective conductive sublayer positioned between the metal mesh sublayer and the electrochromic sublayer.

18. The electronic display of claim 15, further comprising an antenna integrated with the transparent substrate.

19. A method of manufacturing comprising:
dimensioning one or more cells of a metal mesh to form a non-periodic grid; and
coupling the metal mesh to a transparent substrate.

20. The method of claim 19, wherein:
the non-periodic grid represents a modified version of a periodic grid;
the periodic grid comprises a plurality of regularly spaced cells, each cell comprising a plurality of edges and vertices that form a symmetric shape; and
dimensioning the one or more cells of the metal mesh comprises altering one or more cells of the periodic grid by altering, for at least one of the cells of the periodic grid, a length of one or more edges of the cell such that a resulting shape formed by the edges of the cell is non-symmetric.
